(19) United States
(12) Patent Application Publication
(10) Pub. No.: US 2021/0221005 A1
(43) Pub. Date: Jul. 22, 2021

(54) Integrated System Design For A Mobile Manipulation Robot With Socially Expressive Abilities

(71) Applicant: Board of Regents, The University of Texas System, Austin, TX (US)

(72) Inventors: Andrea L. Thomaz, Austin, TX (US); Maxwell Svetlik, Austin, TX (US); Alfredo Serrato, Austin, TX (US); Prashant Rao, Austin, TX (US)

(73) Assignee: Board of Regents, The University of Texas System, Austin, TX (US)

(21) Appl. No.: 17/055,882

(22) PCT Filed: May 14, 2019
(86) PCT No.: PCT/US2019/032139

§ 371 Date: Nov. 16, 2020

Related U.S. Application Data
(60) Provisional application No. 62/671,159, filed on May 14, 2018.

(51) Int. Cl. B25J 11/00; B25J 9/16; B25J 13/00; B25J 9/10; B25J 9/12; B25J 9/00; B25J 5/00

(52) U.S. Cl. CPC B25J 11/0015; B25J 9/1697; B25J 13/006; B25J 5/007; B25J 9/108; B25J 9/12; B25J 9/0009; B25J 9/102

(57) ABSTRACT

Various embodiments of the present technology generally relate to robotics. More specifically, some embodiments of the present technology relate to an integrated system design for a mobile manipulation robot with socially expressive abilities. Some embodiments provide for a robot comprising a socially expressive head unit. The head can have at least two degrees of freedom created by a motor with a planetary gear box and a servo. The motor can be connected to a shell via a support that allows the shell to tilt up and down upon activation of the motor. The shell can include a camera housing configured to receive a camera which can be attached to the support. The motor can be mounted on a rotatable shaft controlled by a servo causing the head unit to pan.

### CROSS-REFERENCE TO RELATED APPLICATION

This application claims priority to U.S. Provisional Application Ser. No. 62/671,159 filed May 14, 2019, which is incorporated herein by reference in its entirety for all purposes.

### TECHNICAL FIELD

Various embodiments of the present technology generally relate to robotics. More specifically, some embodiments of the present technology relate to an integrated system design for a mobile manipulation robot with socially expressive abilities.

### BACKGROUND

Fully integrated mobile manipulation robot platforms that are appropriate for indoor environments and human-robot interactions are of interest to academics and commercial entities. These service robots are designed to work alongside of humans and to perform or assist with a lot of tasks in the daily lives of humans around the house or in the workplace. For example, these service robots can retrieve and deliver objects or perform routine tasks. In order for the individuals to feel more comfortable around these robots, the service robots can be designed with a focus to create an anthropomorphic design that allows the robot to provide expressions that humans can easily interpret.

Simple robotic designs to create social expressiveness may include a screen that shows a face, while more complex designs can have heads that have ten or more degrees of freedom that can move ears, eyes, and other facial features. While the increased number of the degrees of freedom provide for a multitude of expressions and more human-like robots, these designs require more complicated mechanical design and control algorithms. Creating a balance between the anthropomorphic design and complexity can be difficult. It is with respect to these and other problems that embodiments of the present invention have been made.

### SUMMARY

Various embodiments of the present technology generally relate to robotics. More specifically, some embodiments of the present technology relate to an integrated system design for a mobile manipulation robot with socially expressive abilities. Some embodiments provide for a robot comprising a socially expressive head unit, a body, a manipulator arm with a gripper, and a mobile base. The head unit can have at least two degrees of freedom created by a motor with a planetary gear box and a servo. The motor can be connected to a shell (e.g., 3D printed) via a support or support truss that allows the shell to tilt up and down upon activation of the motor.

The shell can include a camera housing configured to receive a camera which can be attached to the support. The motor can be mounted on a rotatable shaft controlled by a servo. As such, activation of the servo can rotate the shaft causing the head unit to pan. In some embodiments, the shaft may be fitted with axial bearings to absorb forces from the head unit. The body can be connected to the head unit (e.g., via the shaft which can be covered by a neck shell). The mobile base can be located at a first end portion of the body and include pair of wheels or engaging drivers coupled to a drive assembly operative to propel the robot along a surface.

In some embodiments, the head unit can include two light emitting diode (LED) panels positioned on opposite sides of the shell. The LED panels can be configured to change color indicating an operative state (e.g., listening, idle, processing, busy, etc.) of the robot. The shell of the head unit may include two translucent panes behind which each of the LED panels can be affixed.

In some embodiments, the proximal end of the manipulator arm can be coupled to the body and a distal end connected to the gripper. The manipulator arm can include multiple segments (e.g., 3, 4, 7, etc.) connected by actuated joints to allow the manipulator arm to move to retrieve or deliver objects. The distal end of the manipulator arm can be connected to the gripper via a gripper interface providing a transition between the manipulator arm and the gripper. In some embodiments, the gripper interface can include a wrist housing with a rounded proximal end to attach to the distal end of the manipulator arm while a rectangular distal end can be used connect to a proximal end of the gripper. The manipulator arm and the gripper utilize different communication protocols. Some embodiments of the gripper interface include a wireless bridge allowing the gripper to be independently controlled from the manipulator arm.

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

### BRIEF DESCRIPTION OF THE DRAWINGS

Embodiments of the present technology will be described and explained through the use of the accompanying drawings.

FIG. 1 is a view of a robot with socially expressive capabilities according to one or more embodiments of the present technology.

FIG. 2 is a side view of the robot shown in FIG. 1.

FIGS. 3A-3D show various views of a head unit of the robot shown in FIGS. 1 and 2.

FIG. 4 is a view of a cross section of the head unit of the robot as viewed from the side.

FIG. 5 is a cross section of the head unit of the robot as viewed from the front with various components hidden to show a drive mechanism.

FIG. 6 is an exploded view of the head unit of the robot with various components hidden to show a drive assembly.

FIG. 7 is a cross section of the exploded view of the head unit with various components hidden to show the drive assembly.

FIGS. 8A-8B are exploded views of various embodiments of the gripper interface connecting a forearm to a gripper assembly.

FIGS. 9A-9B illustrate cross sections of two embodiments of the gripper interface as viewed from the side with various components hidden.

FIG. 10 is a block diagram illustrating the electrical connections between various components of the gripper interface.

FIGS. 11A-11B illustrate the layout of a customized printed circuit board that may be used in the gripper interface.

FIGS. 12A-12D illustrate pinouts for components of the gripper interface that may be used with the robot.

FIGS. 13A-13B are block diagrams illustrating the electrical layout of various components that may be used in the robot.

FIG. 14A illustrates a block diagram illustrating the electrical and communication connections between a Kinova arm wrist connector and a Robotiq-85 Gripper.

FIG. 14B illustrates the layout of a customized printed circuit board that may be used to connect Kinova arm wrist connector and a Robotiq-85 Gripper.

FIGS. 14C-14D illustrate pinouts for components of the gripper interface that may be used with the robot in some embodiments.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

Various embodiments of the present technology generally relate to robotics. More specifically, some embodiments of the present technology relate to an integrated system design for a mobile manipulation robot with socially expressive abilities. Various embodiments of the present technology provide for an aesthetic social human-robot interaction (HRI) service robot with an appropriate level of sensors to perform a variety of functions. For example, various embodiments can carry out basic tasks autonomously, learn from human demonstrations, deploy learned actions from machine learning algorithms, and/or perform other functions.

Some embodiments of the service robot include a pan and tilt head unit design to support heavier structure. The head unit can include a shell that is mounted along with a camera. The head unit can have a motion that is human like—more like a neck than just a pan tilt on a camera. The head unit can have two degrees of freedom that are linked (i.e., pan and tilt). The mechanical design of the head unit can use servomotor to control the pan, and a brushless direct current (DC) motor with planetary gearbox to control the tilt. Each axis of rotation can feature appropriate bearings for the required load, and can be constructed from various materials (e.g., machined aluminum).

In some embodiments, a manipulator arm can be connected to a body of the service robot. For example, the proximal end of the manipulator arm can be coupled to the body and a distal end connected to the gripper. The manipulator arm can include multiple segments (e.g., 3, 4, 7, etc.) connected by actuated joints to allow the manipulator arm to move to retrieve or deliver objects. The distal end of the manipulator arm can be connected to the gripper via a custom gripper interface providing a transition (electrically and mechanically) between the manipulator arm and the gripper. For example, in some embodiments, the gripper interface can include a wrist housing with a rounded proximal end to attach to the distal end of the manipulator arm while a rectangular distal end can be used connect to a proximal end of the gripper. The manipulator arm and the gripper utilize different communication protocols. Some embodiments of the gripper interface include a wireless bridge allowing the gripper to be independently controlled from the manipulator arm.

In the following description, for the purposes of explanation, numerous specific details are set forth in order to provide a thorough understanding of embodiments of the present technology. It will be apparent, however, to one skilled in the art that embodiments of the present technology may be practiced without some of these specific details. The robot can include various special-purpose hardware, programmable circuitry appropriately programmed with software and/or firmware, and the like.

The phrases “in some embodiments,” “according to some embodiments,” “in the embodiments shown,” “in other embodiments,” and the like generally mean the particular feature, structure, or characteristic following the phrase is included in at least one implementation of the present technology, and may be included in more than one implementation. In addition, such phrases do not necessarily refer to the same embodiments or different embodiments.

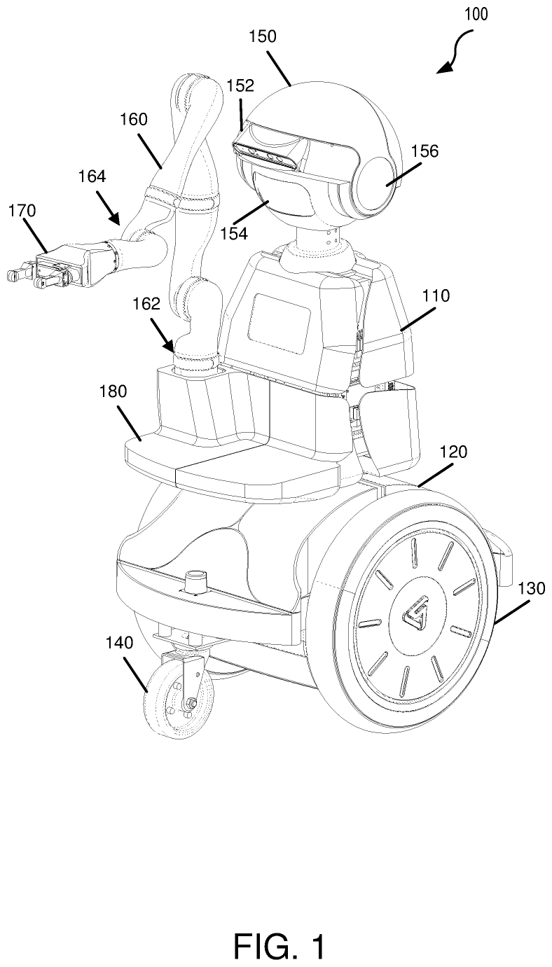

FIG. 1 is a view of a robot 100 with socially expressive capabilities according to one or more embodiments of the present technology. As shown in FIG. 1, robot 100 has body 110, mobile base 120, drive wheels 130, caster wheels 140, head unit 150, manipulator 160, gripper 170, and tray 180. Body 110 and/or mobile base 120 can include various power sources (e.g., a battery), processors, controller, sensors, drive motors, and/or other components. The pair of drive wheels 130 are located outside of mobile base 120 which protects a drive assembly (not shown) operative to rotate drive wheels 130 to propel the robot 100 along the ground, floor, or other support surface. Additional balancing support can be provided by caster wheels 140 preventing robot 100 from falling forward or backwards. For example, when robot 100 is powered off or in a low power conservation mode, caster wheels 140 can provide needed support to keep robot 100 upright.

Drive wheels 130 may be part of a differential drive system allowing drive wheels to independently move. As such, by changing the relative rate of rotation of drive wheels 130, robot 100 can navigate ground obstacles or reach desired destinations without additional steering components. While the embodiments shown in FIG. 1 include drive wheels 130, alternative ground-engaging drivers such as endless tread (e.g., tracks) may be used in some embodiments. In accordance with various embodiments, mobile base 120 and drive wheels 130 can be based on the Segway Robotic Mobility Platform (RMP). Mobile base 120 can have a relatively small footprint, while still providing enough moving power to move the entire robot 100 along the ground or other surface. In some embodiments, body 110 and mobile base 120 may be able to rotate relative to one another.

Head unit 150 can be rotatably coupled to body 110 and may include one or more cameras 152, visual indicators 154 and 156, speakers (not shown), microphones (not shown), lidar sensors (e.g., Hokuyo 2D), sonar sensors (e.g., from MaxBotix), and/or other sensors. These sensors can be used to provide feedback for navigation and localization algorithms. For example, cameras 152 can capture images or video of a local environment of robot 100. These images and/or video can be used to identify object locations that robot 100 may be tasked with picking up and delivering. In accordance with some embodiments, the visual indicators 154 and 156 can include multiple light emitting diodes (LEDs) to change color, pattern, and the like provide visual feedback to humans within the room as to the state of the robot (e.g., processing, listening, etc.). The sensors and indicators may also be located in other locations, such as but not limited to body 110 and mobile base 120, within robot 100.

Manipulator 160 and gripper 170 can allow robot 100 to interact in various environments and perform a variety of useful tasks (e.g., object retrieval and delivery, opening doors or boxes, and the like. Manipulator 160 shown in FIG. 1 includes a proximal end portion 162 rotatably coupled to the body 110. A distal end portion or forearm 164 of manipulator 160 can be rotatably coupled to gripper 170. Manipulator 160 can include multiple segments connected at actuated joints. Manipulator 160 and gripper 170 can provide various force and position feedback signals that can be useful for machine learning techniques. Cameras 152 in head unit 150 can provide visual feedback for navigation of manipulator 160 and/or gripper 170.

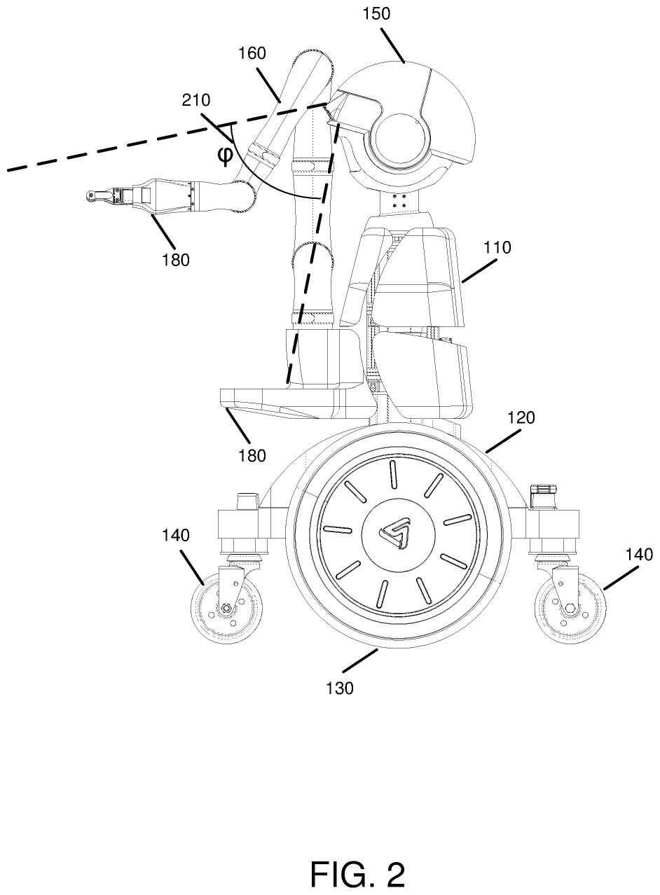

As illustrated in FIG. 2, camera 152 can provide a field of field of view 210 that is designed to keep manipulator 160, gripper 170, and tray 180 in view while performing various tasks. For example, robot 100 may be tasked with delivering an object (not shown) from tray 180 to a human or a different surface (e.g., a table). Tray 180 may be integrated into body 110 or removable from body 110. Using feedback from cameras 152, encoders, force signals from gripper 170, and the like, robot 100 can autonomously plan and execute desired tasks. As a result, robot 100 can retrieve and/or deliver multiple objects at a time and keep track of the locations of each of the multiple objects while transferring the object from one location to another. In accordance with various embodiments, the command can be received as voice inputs a human, determined independently as a subtask by robot 100, or via a signal generated by a computing device (e.g., smart watch, computer, tablet, etc.).

The angle of the camera 152 and head unit 150 can provide a tilt motion that is not too unnatural or unpleasing to a human. For example, the tilt motion may be limited to a range between −30 degrees and +60 degrees in some embodiments. In other embodiments, the range of the tile motion of head unit 150 may be higher or lower. The tray may always visible by camera 152 in some embodiments thereby allowing identification of objects separated from the robot (e.g., on a table) while allowing any objects on tray 180 to remain in the field of view 210 of camera 152.

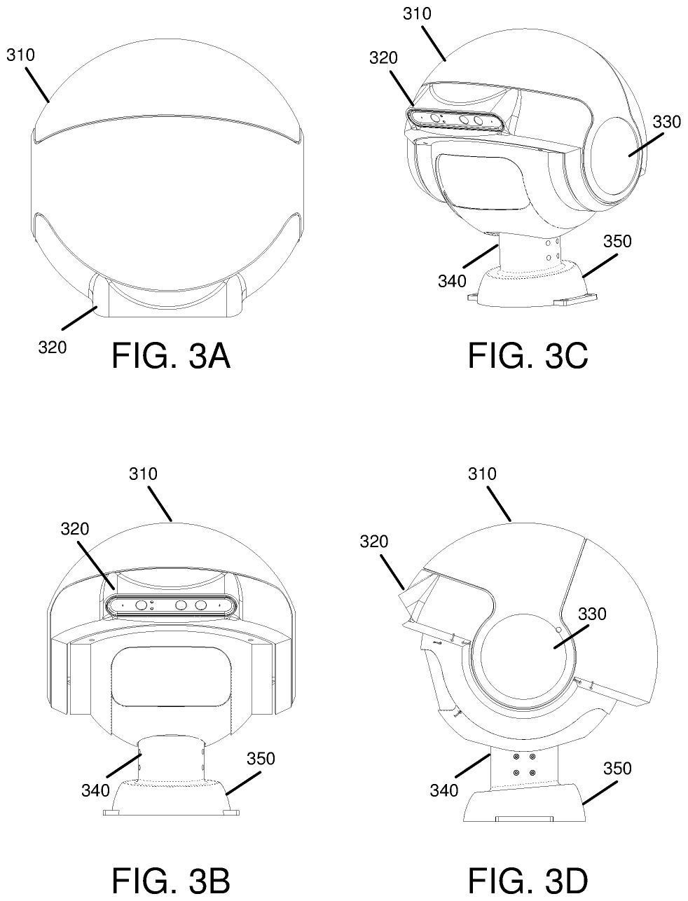

FIGS. 3A-3D show various views of head unit 150 of robot 100 as illustrated in FIGS. 1 and 2. As illustrated in FIGS. 3A-3D, head unit 150 can include shell 310, camera housing 320, LED panels 330, neck 340, and neck shell 350. In some embodiments, shell 310 may be approximately thirteen inches in diameter with a face (e.g., camera housing and front LED panel 330) approximately ten inches in diameter in some embodiments. In other embodiments, shell 310 and the face may be smaller or larger to scale with the size of body 110. The front LED panel 330 (or other electronic display) can be used to display socially expressive facial features such as moving and blinking eyes, eyebrows that can be raised or lowered, nose, and mouth that can change shapes (e.g., from a smile to a frown).

As illustrated in FIGS. 3A-3D, camera housing 320 can be located within shell 310 such that the gaze of the robot matches where head unit 150 is looking. LED panels or strips 330 can be located in the ears. LED panels 330 can change color to provide visual indications of the operational modes of robot 100. For example, in some embodiments, LED panels 330 can turn red when robot 100 is processing and not listening for human voice commands. LED panels 330 may turn green and blink when robot 100 is listening to commands. LED panel 330 may turn blue and white showing a heartbeat to represent that robot 100 is idle.

There were two main considerations when modeling social abilities of robot 100: the ability to gesture with head unit 150 and to appear aesthetically intelligent and sociable. These considerations can be achieved in some embodiments with the design a pan-tilt motor system using off the shelf actuators and creation of custom shells for the robot, respectively. In the embodiments illustrated in FIGS. 3A-3D, head unit 150 can tilt forward and back and rotate around neck 340. In some embodiments, the rotation of head unit 150 may be limited to ±90 degrees. The rotation may be larger or smaller in other embodiments.

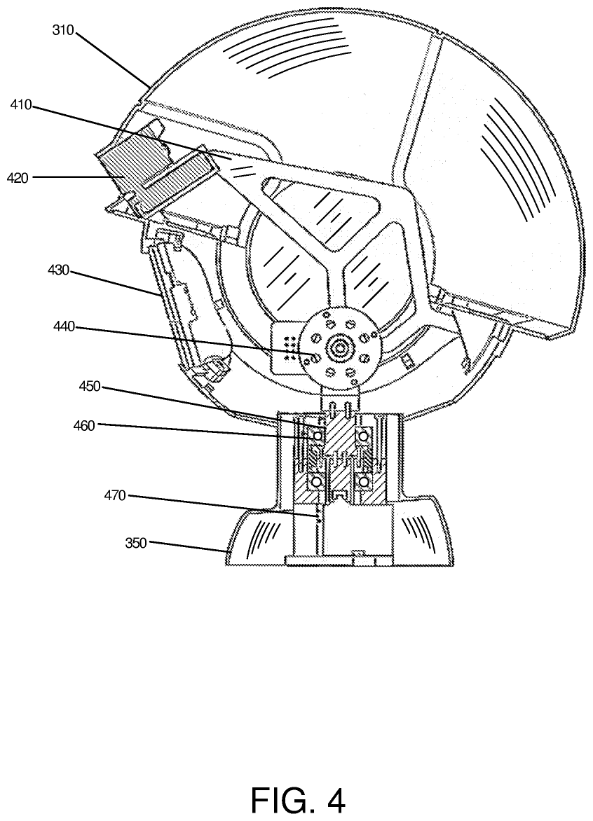

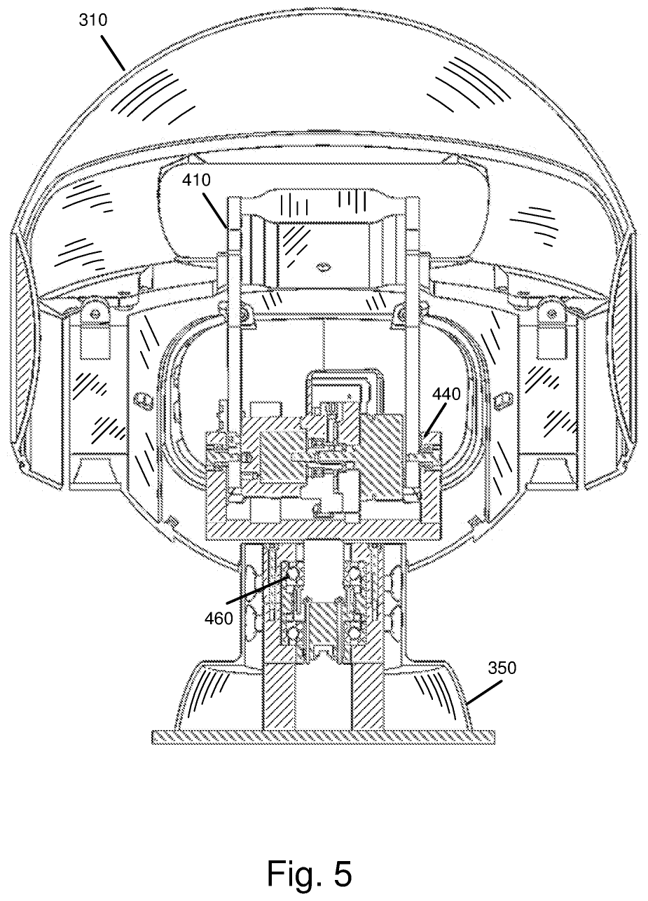

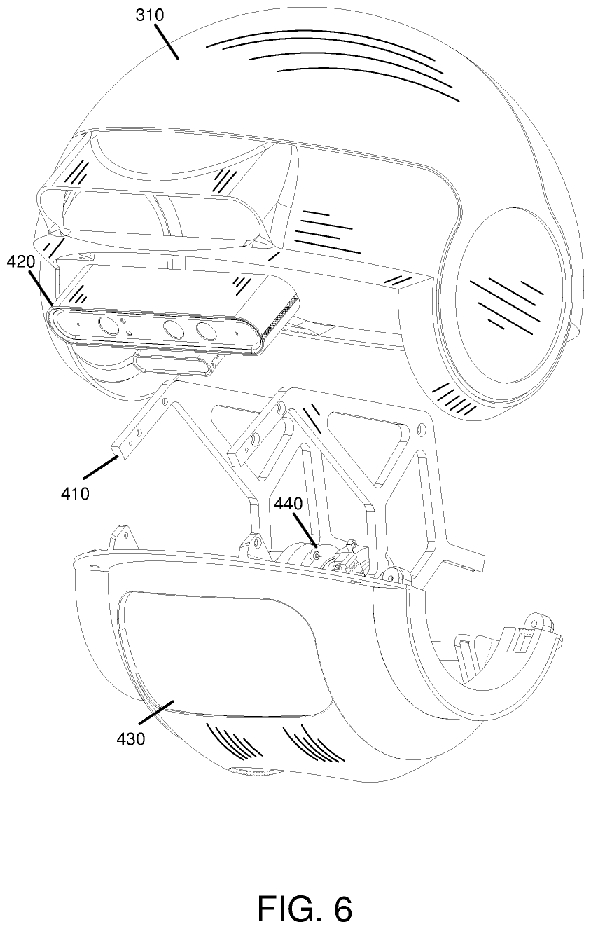

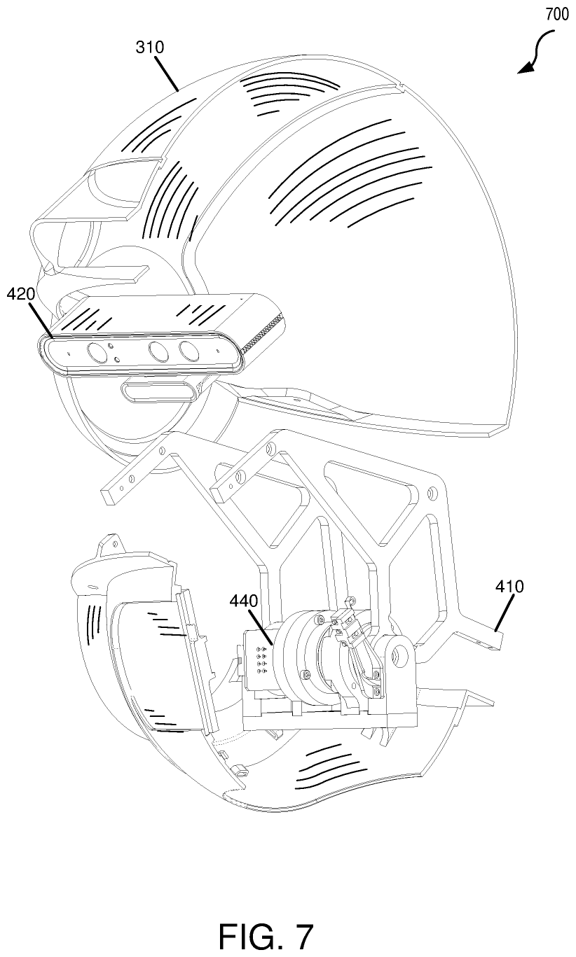

FIGS. 4 and 5 provide cross sections of head unit 150 of robot 100 as viewed from the side and front, respectively, to show a drive assembly for head unit control and movement. As illustrated in FIGS. 4 and 5, head unit 150 can include shell 310, support (or support truss) 410, camera 420, LED panel support 430, motor with planetary gearbox 440, shaft 450, dual angular contact ball bearings 460, servo 470 and neck shell 350. Shell 310 and neck shell 350 can be plastic shells designed to surround internal components while providing an aesthetically pleasing head unit to nearby humans. Camera 420 and shell 310 can be held together by support 410. Support 410 can also connect from motor 440 to the shell 310 while providing support for camera 420 and front LED panel 430 along with various screens and all internal electronic components (not shown). FIGS. 6 and 7 provide exploded views of head unit 150 with various components hidden to show the drive assembly.

In order to allow attention-based gestures, various embodiments of head unit 150 of robot 100 move head unit 150 in a similar way that a human does. For example, in some embodiments, head unit 150 can have at least two degrees of freedom (i.e., movement in at least two coordinate frames). As such, head unit 150 may be programed to look down while thinking, directly look at humans speaking to robot 100, nod yes or no, and the like. To allow head unit 150 to accomplish the desired movements, support 410 may be an aluminum structure support that is also coupled to motor 440 with planetary gearbox. Shaft 450 can be made from aluminum and fitted with two axial bearings 460 to absorb the force of the weight of the head.

Motor 440 with the planetary gearbox can tilt head unit 150 up and down while servo 470 (e.g., a Dynamixel servo) can allow head unit 150 to pan. The gearbox can have a high gear ratio to support the weight of the head. For example, in some embodiments the gearbox may have a gear ratio (e.g., 1:45) to give high torque so that head unit 150 does not move even when motor 440 is turned off. This ratio may be raised or lowered depending the materials used to create the shell, the set of electronic components integrated into head unit 150, size of shell 310, and/or other factors. As such, various embodiments do not need load bearing springs to keep the head in place when motor 440 is deactivated. In addition, motor 440 and servo 470 may be selected to have a very low backlash to provide a very smooth motion to improve camera image detection by reducing noise created by jerky movements of head unit 150.

The front LED panel 430 can sit behind a semi-translucent pane (e.g., white acrylic) and be used to make expressions (e.g., blink, avert eyes, smile, etc.) that can be interpreted by nearby humans. Front LED panel 430 may present traditional facial features such as two eyes, a mouth, and a nose. In some embodiments, front LED panel 430 may have a more digital look (e.g., a classic 8-bit digital character for the eyes) so that facial expressions from the front LED panel in head unit 150 still appear like a robot.

Electrically, communication of motor 440 and servo 470 can be streamlined to a processor (not shown) to allow the processor to read position measurements (e.g., from encoders) and to send control signals to command the position of motor 440 and servo 470 to pan and tilt head unit 150. For cost-savings, some embodiments may use a lower torque motor 440 than for the pan servo 470. A higher torque motor may be chosen for the tilt motor 440, since the tilt motor 440 has more constraints (e.g., need to balance the weight of the head unit 150 against gravity and move smoothly). Motor 440 and servo 470 may communicate using different signaling protocols, but may be able to communicate through USB with the additional controllers (e.g., EPOS-2 and RS-to-USB motor controllers).

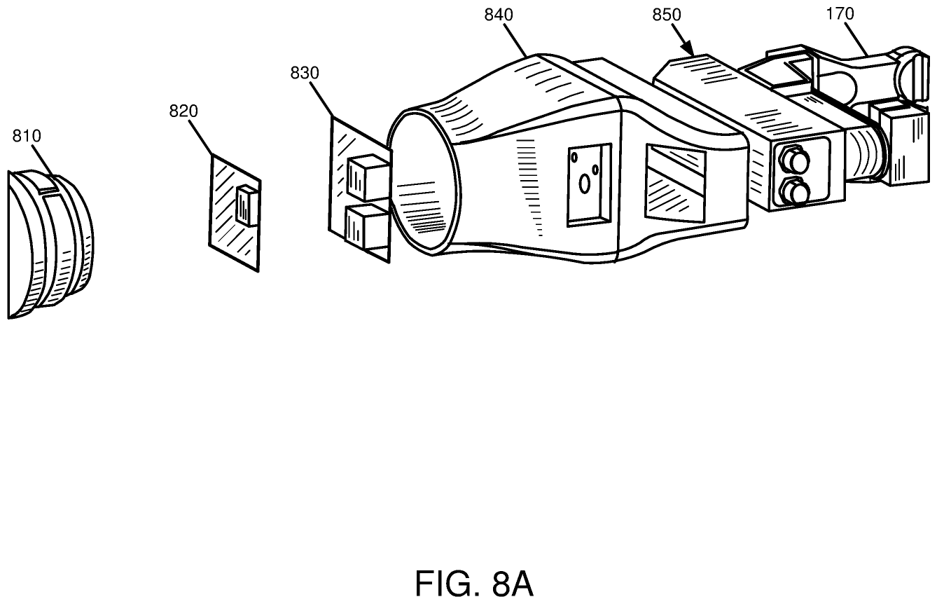

FIG. 8 is an exploded view of gripper interface connecting forearm 164 to gripper assembly 170 on manipulator arm 160. In accordance with some embodiments, manipulator arm 160 can be a seven degree of freedom robot manipulator (e.g., Kinova Jaco2 7-degree of freedom robot manipulator). Manipulator arm 160 can be used to provide sensory feedback and integrated with a selected gripper 170 (e.g., the Weiss WSG-32 Gripper), which can provide additional feedback for sensing force and pressure in the finger tips. The additional feedback provided by gripper 170 allows for precise manipulation of objects that are sensitive to the force applied when grasping using gripper 170. In addition, this feedback may be used to sense when an object is slipping out of gripper 170.

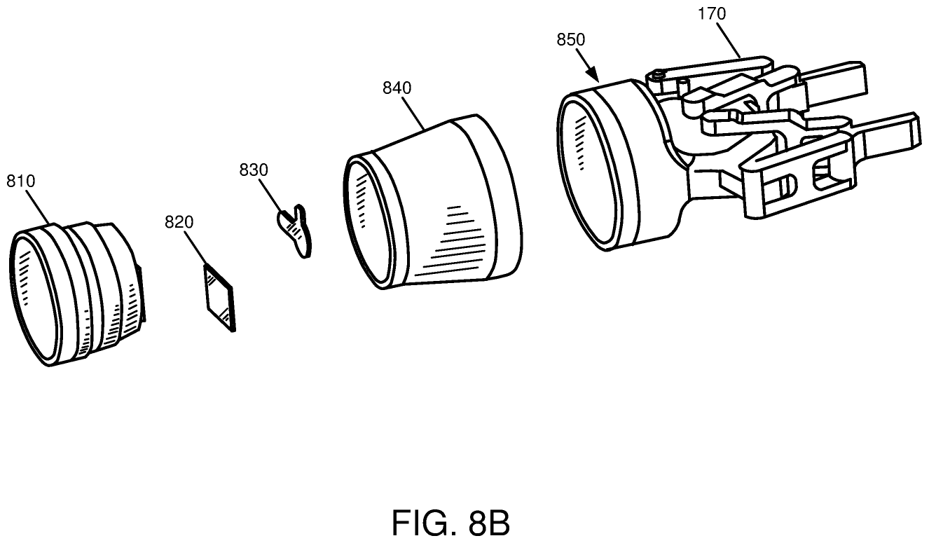

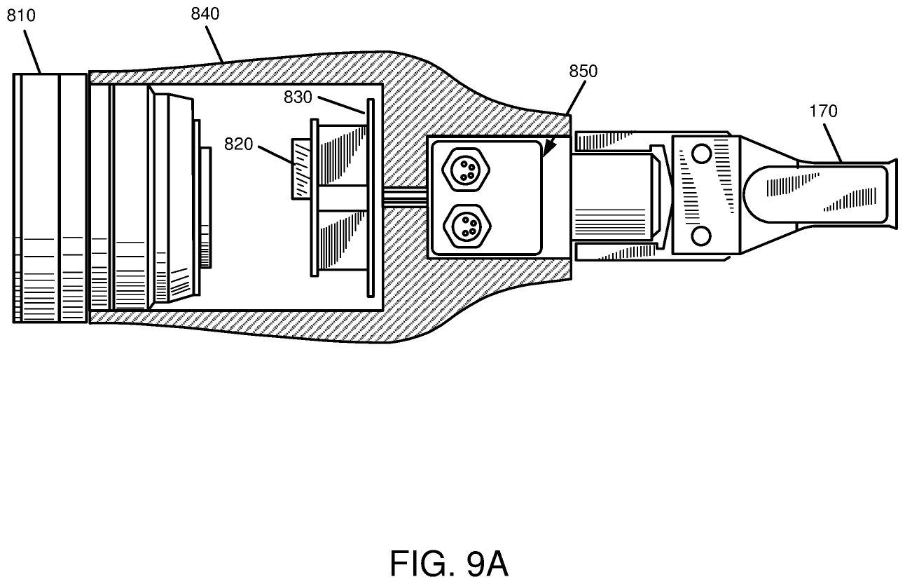

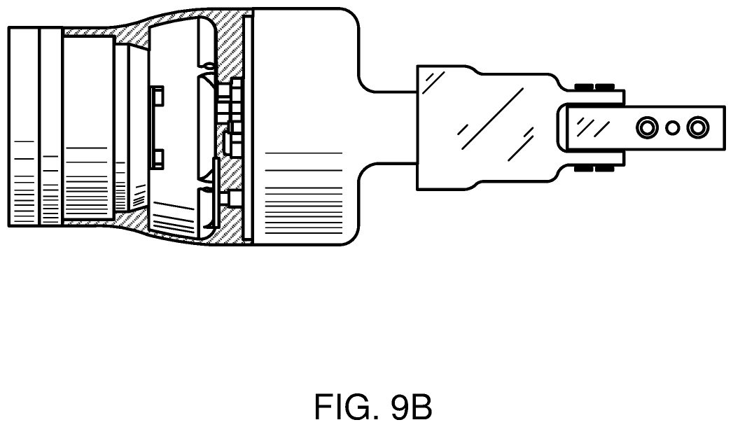

The mechanical and electrical integration of gripper assembly 170 and manipulator arm 160 is illustrated in FIGS. 8, 9, and 10. The end portion 810 of manipulator arm 160 can be connected to gripper 170 using printed circuit board 820, wireless bridge 830, and wrist housing 840. The mechanical connection between manipulator arm 160 and gripper 170 can be a modular design to allow for easy assembly and disassembly (e.g., for maintenance). The shape of wrist housing 840 can be small enough as to not be visually or aesthetically over bearing while providing a smooth transition between the shapes of the wrist end 810 of manipulator arm 160 and rectangular profile 850 of the interface for gripper 170. The mechanical design illustrated can include a machined or 3D printed wrist housing 840 that protects electronics (e.g., printed circuit boards 820 and 830) and cables used to interface the two systems.

Wrist housing 840 can be modeled using a lofted boss to interface the circular profile of end portion 810 of manipulator arm 160 to the rectangular profile 850 of the gripper 170. One end of wrist housing 840 can have mounting holes matching those of the robotic manipulator arm 160 (e.g., Kinova manipulator), while the other end can have mounting holes for gripper 170. PCB 820 needs to be small enough to fit within wrist housing 840 and have the ability to handle large currents. Some embodiments address this issue with a 2-layer design and use of larger trace widths. PCB 820 can be used in order to avoid external wire routing. Having external wires between gripper 170 and manipulator arm 160 would have impinged movement of the arm.

Depending on the gripper and manipulator arm selected for use with robot 100, the communication protocol used by gripper 170 (e.g., the Weiss WSG-32) may be incompatible with the communication protocol of the manipulator arm 160. For example, gripper 170 may have an ethernet-based protocol which is incompatible with a feed-through communication protocol of a selected manipulator arm 160 (e.g., Kinova Jaco 7-DOF arm RS485). As such, wireless bridge 830 can be used to access gripper 170 as an independent unit. To provide power to gripper 170, that can run on the same supply voltage (24V) as manipulator arm 160, power connections at the wrist end portion 810 of the manipulator arm 160 may be used.

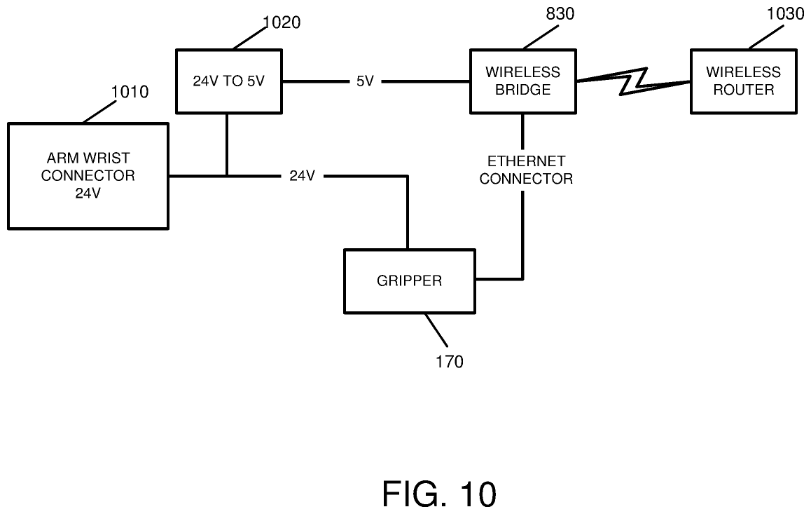

The connector 1010 (in FIG. 10) on wrist end portion 810 of manipulator arm 160 of some commercial arms (e.g., Kinova Jaco 7-DOF arm RS485) can use a flexible flat ribbon cable, which is non-standard and difficult to directly interface with. A flexible flat ribbon cable can be attached to the connector 1010 on the wrist end 810 of manipulator arm 160 and an identical connector on PCB 820. The 24V power lines can be routed to a two-pin connector to act as the gripper's power and to a 5V voltage regulator 1020 for the wireless bridge's power. The output of the regulator is routed to the wireless bridge 830. Also, wireless bridge 830 may use a 5V power supply. Thus, a 2-layer custom PCB (printed circuit board) 820 can be used to interface with the flexible flat ribbon cable connector and use the arm's power lines to power both gripper 170 and wireless bridge 830.

Wireless bridge 830 can be powered (e.g., 5V) through the custom PCB 820 so the interface PCB on the arm gives out the needed voltage (e.g., 24V) to gripper 170. Wireless bridge 830 wirelessly connects to a router providing an independent gripper 170 with no extra cabling running through manipulator arm 160 is needed. Status LED's (e.g., on gripper 170, wireless bridge 830, etc.) can be visible to user or technician allowing for quick determination as to the status of the components. For example, the LED's can allow the user or technician to quickly determine whether gripper 170, wireless bridge 830, etc. are connected to a wireless network via wireless router 1020 (in FIG. 10), are receiving power, are working, are in an error state, or the like. The voltages and electrical connections that can be used in some embodiments are illustrated in FIG. 10.

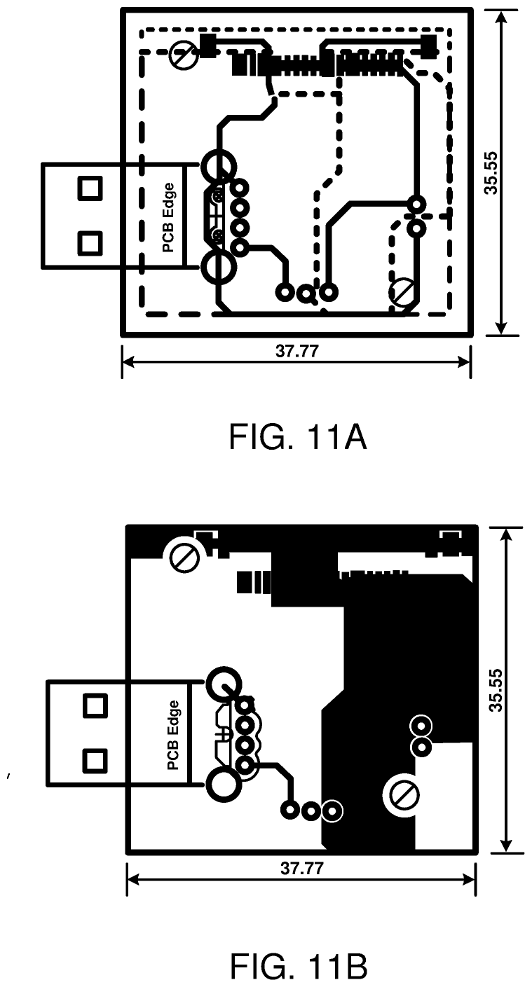

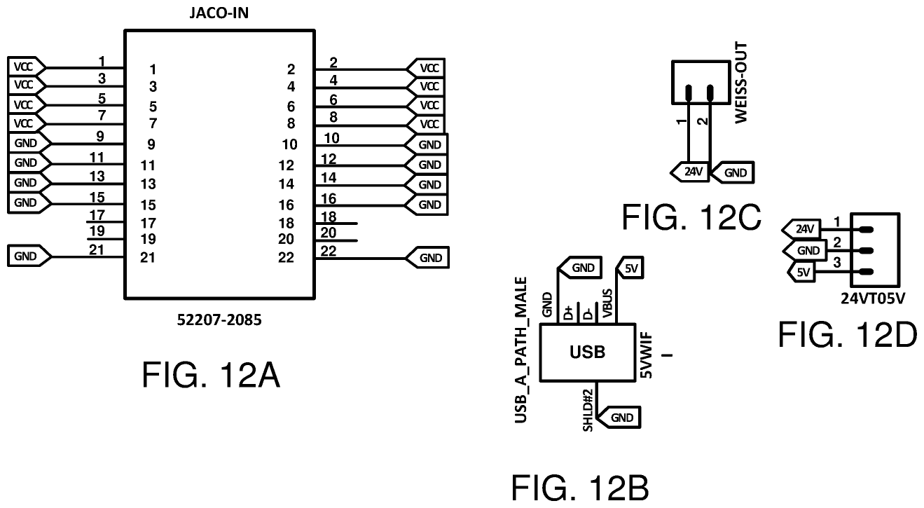

FIGS. 11A-11B illustrate the layout of a customized printed circuit board that may be used in the gripper interface. For example, the Weiss WSG-32 Gripper, used in some embodiments, communicates using a four wire ethernet protocol whereas the Kinova arm has feed through capabilities for two wire RS485 communication. To solve the problem, a PCB was designed which powers the WSG gripper using the 24V output at the Kinova wrist and then converts the 24V to 5V to power a wireless bridge. The wireless bridge connects to the WSG-32 by means of an ethernet cable and then wireless connects the gripper to the primary wireless router allowing for communication with the gripper. To manage heat dissipation due to the large currents, some embodiments use a wide trace two layered PCB design as illustrated in FIGS. 11A-11B. FIGS. 12A-12D illustrate pinouts for components of the gripper interface that may be used with the robot.

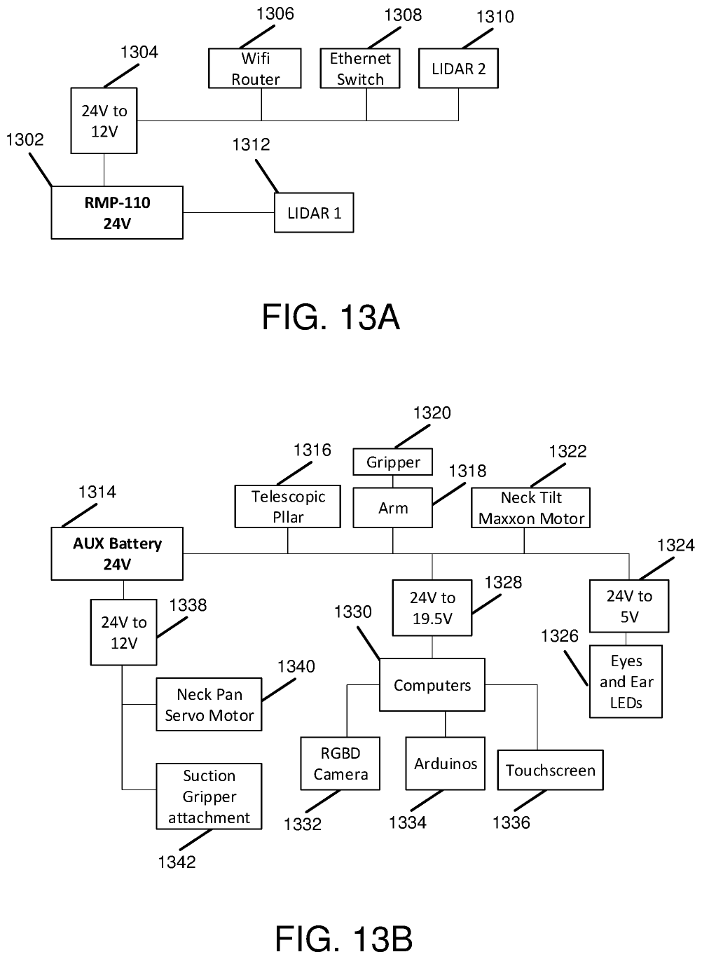

FIGS. 13A-13B are block diagrams illustrating the electrical layout of various components that may be used in the robot. As illustrated in FIG. 13A, base 120 of the robot 100 may use a Segway Robotic Mobility Platform (RMP) 1302 (e.g., RMP-110). RMP 1302 can be connected to a voltage regulator to convert 24V to 12V which can power WiFi router 1306, ethernet switch 1308, and lidar 1310 while a second lidar sensing unit 1312 can be power directly by RMP 1302. FIG. 13B illustrates a 24V auxiliary power supply 1314 that power telescopic pillar 1316, arm 1318 and gripper 1320, and neck tilt motor 1322. The 24V auxiliary power supply 1314 can be connected to step down voltage regulators 1324, 1328, and 1338 to provide output voltages of 5V, 19.5V, and 12V to power the eyes and ear LEDs 1326, computers 1330, neck pan servo motor 1340 and suction gripper attachment 1342. The onboard computers 1330 may be used to power and/or control RGBD camera 1332, programmable circuit boards (e.g., Arduinos) 1334, and touchscreen 1336.

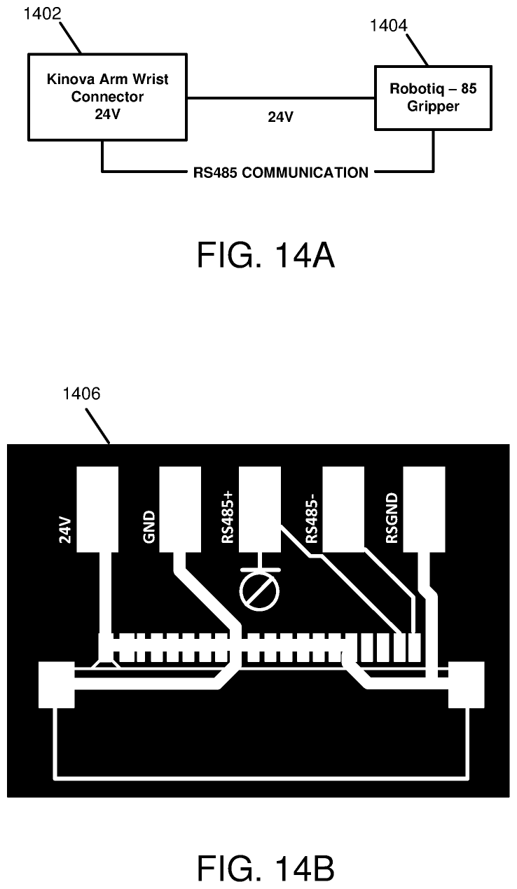

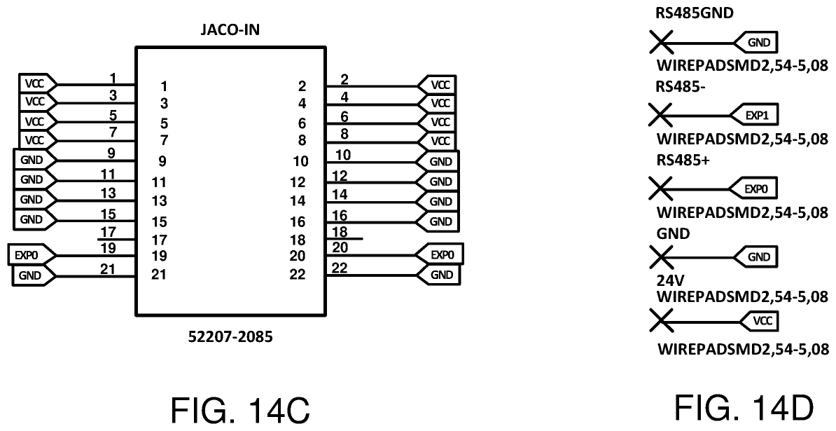

FIG. 14 illustrates a block diagram illustrating the electrical and communication connections between a Kinova arm wrist connector and a Robotiq-85 Gripper. As illustrated in FIG. 14A, the Robotiq gripper 1404 uses 24V for power and communicates using RS485 protocol to communicate with wrist connector 1402. FIG. 14B illustrate the layout of a customized printed circuit board 1406 that may be used to connect Kinova arm wrist connector and a Robotiq-85 Gripper. Interface PCB 1406 allows the Robotiq-85 Gripper to derive power from the Kinova Jaco Arm and route communications through feedthrough RS485 lines on the Kinova arm. The gripper's communication channel can then be accessed by the control computer through a port at the base of the arm using an RS485 to USB converter. FIGS. 14C-14D illustrate pinouts for components of the gripper interface that may be used with the robot in some embodiments.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

1. A robot comprising:
a head unit with at least two degrees of freedom, the head unit including:
a camera to capture images or video of a local environment;
a shell having a camera housing fitted to receive the camera;
a motor with a planetary gearbox;
a support connecting the shell to the motor thereby allowing the shell to tilt up and down upon activation of the motor;
a servo; and
a shaft fitted with two axial bearings to absorb forces from the head unit, wherein the motor with the planetary gearbox is mounted on the shaft, and wherein the shaft can be rotated by the servo causing the shell to pan;
a body connected to the head unit; and
a mobile base located at a first end portion of the body, the mobile base having a pair of wheels, each wheel coupled to a drive assembly operative to propel the robot along a surface.

2. The robot of claim 1, wherein the head unit further comprises two light emitting diode (LED) panels positioned on opposite sides of the shell, the two LED panels configured to change color to indicate two or more operative states of the robot.

3. The robot of claim 2, wherein the shell of the head unit includes two translucent panes behind which each of the two LED panels are affixed to the shell.

4. The robot of claim 1, further comprising a manipulator arm having a proximal end coupled to the body and a distal end connected to a gripper, wherein the manipulator arm includes multiple segments connected by actuated joints to allow the manipulator arm to move to retrieve or deliver objects.

5. The robot of claim 4, wherein the distal end of the manipulator arm is connected to the gripper via a gripper interface having a wrist housing with a rounded proximal end to attach to the distal end of the manipulator arm, the wrist housing further having a rectangular distal end to connect to a proximal end of the gripper.

6. The robot of claim 5, wherein the manipulator arm and the gripper utilize different communication protocols, and wherein the gripper interface includes a wireless bridge allowing the gripper to be independently controlled from the manipulator arm.

7. The robot of claim 1, wherein the planetary gearbox has a gear ratio to provide sufficient torque so that the head unit does not move even when the motor is turned off.

8. The robot of claim 7, wherein the gear ratio is above one to thirty.

9. An anthropomorphic robotic head unit with socially expressive capabilities comprising:
a camera to capture images of a local environment;
a shell having a camera housing fitted to receive the camera;
a motor with a planetary gearbox;
a support connecting the shell to the motor thereby allowing the shell to tilt up and down upon activation of the motor;
a servo; and
a shaft fitted with two axial bearings to absorb forces from the anthropomorphic robotic head unit, wherein the motor with the planetary gearbox is mounted on the shaft, and wherein the shaft can be rotated by the servo causing the shell to pan.

10. The anthropomorphic robotic head unit of claim 9, further comprising two light emitting diode (LED) panels positioned on opposite sides of the shell, the LED panels configured to change color to indicate two or more operative states of the anthropomorphic robotic head unit or a robot associated therewith.

11. The anthropomorphic robotic head unit of claim 10, wherein the two or more operative states include listening, processing, and idle.

12. The anthropomorphic robotic head unit of claim 10, wherein the shell further includes two translucent panes behind which each of the two LED panels are affixed.

13. The anthropomorphic robotic head unit of claim 9, further comprising a front LED panel to display facial features including two eyes, a nose, and a mouth.

14. The anthropomorphic robotic head unit of claim 9, wherein the planetary gearbox has a gear ratio to provide sufficient torque so that the anthropomorphic robotic head unit does not move even when the motor is turned off.

15. The anthropomorphic robotic head unit of claim 13, wherein the planetary gearbox has a gear ratio to provide sufficient torque so that the anthropomorphic robotic head unit does not move even when the motor is turned off.

16. A robot comprising:
a socially expressive head unit with at least two degrees of freedom, the socially expressive head unit including:
a set of electronic components including a camera to capture images or video of a local environment of the robot and an electronic display to present facial features;
a shell with a front portion having a camera housing fitted to receive the camera and semi-translucent pane behind which the electronic display is secured;
a motor with a planetary gearbox;
a support truss connecting the shell to the motor thereby allowing the shell to tilt up and down upon activation of the motor and wherein the set of electronic components can be mounted to the support truss;
a servo; and
a shaft to which the motor with the planetary gearbox is mounted, and wherein the shaft can be rotated by activation of the servo causing the shell to pan;
a body connected to the socially expressive head unit, wherein the body has an integrated tray; and
a mobile base located at a first end portion of the body, the mobile base having ground engaging drivers to propel the robot along a surface and two casters.

17. The robot of claim 16, wherein the socially expressive head unit further comprises two light emitting diode (LED) panels positioned on opposite sides of the shell, the LED panels configured to change color to indicate at least two operative states of the robot.

18. The robot of claim 16, further comprising a manipulator arm having a proximal end coupled to the body and a distal end connected to a gripper, wherein the manipulator arm includes multiple segments connected by actuated joints to allow the manipulator arm to move to retrieve objects from, or deliver objects to, the integrated tray on the body.

19. The robot of claim 18, wherein the distal end of the manipulator arm is connected to the gripper via a gripper interface having a wrist housing with a rounded proximal end to attach to the distal end of the manipulator arm, the wrist housing further having a rectangular distal end to connect to a proximal end of the gripper.

20. The robot of claim 19, wherein the manipulator arm and the gripper utilize different communication protocols, and wherein the gripper interface includes a wireless bridge allowing the gripper to be independently controlled from the manipulator arm.
